(19) United States
(12) Patent Application Publication
(10) Pub. No.: US 2016/0061060 A1
(43) Pub. Date: Mar. 3, 2016

(54) COMBINED CYCLE POWER PLANT THERMAL ENERGY CONSERVATION

(71) Applicant: General Electric Company, Schenectady, NY (US)

(72) Inventors: Sanji Ekanayake, Mableton, GA (US); Julio Enrique Mestroni, Powder Springs, GA (US); Alston I. Scipio, Mableton, GA (US)

(21) Appl. No.: 14/820,728

(22) Filed: Aug. 7, 2015

Related U.S. Application Data
(60) Provisional application No. 62/042,814, filed on Aug. 28, 2014.

(51) Int. Cl. F01K 23/10; F02C 7/00

(52) U.S. Cl. CPC F01K 23/10; F02C 7/00

(57) ABSTRACT

A combined cycle power plant comprises a compressor, a combustion section including a compressor discharge casing which is disposed downstream from the compressor, a turbine disposed downstream from the combustion section and an exhaust duct disposed downstream from the turbine section. The compressor, the compressor discharge casing, the turbine and the exhaust duct define a primary flow passage through the gas turbine. A heat recovery steam generator is in thermal communication with the exhaust duct and in fluid communication with a steam turbine. A blower is in fluid communication with the primary flow passage upstream from the heat recovery steam generator such that the blower draws compressed air from the primary flow passage during turning gear operation of the gas turbine.

### CROSS-REFERENCE TO RELATED APPLICATIONS

The present application is based upon and claims priority to U.S. Provisional Patent Application No. 62/042,814, filed on Aug. 28, 2014, the disclosure of which is hereby incorporated by reference herein in its entirety for all purposes.

### FIELD OF THE INVENTION

The present invention generally involves a combined cycle power plant. More specifically, the invention relates to a system and method for conserving thermal energy within a heat recovery steam generator portion of the combined cycle power plant during turning-gear and/or non-fired operation of the gas turbine.

### BACKGROUND OF THE INVENTION

One type of combined cycle gas turbine power plant utilizes at least one gas turbine and at least one steam turbine, in combination, to produce electric power. The power plant is arranged such that the gas turbine is thermally connected to the steam turbine through a heat recovery system such as a heat recovery steam generator (“HRSG”). The gas turbine generally includes a compressor section, a combustion section disposed downstream from the compressor section and a turbine section which is downstream from the combustion section. A rotor shaft of the gas turbine is coupled to a generator. A rotor shaft of the steam turbine may be coupled to the same generator or to a separate generator.

The HRSG generally includes one or more heat exchangers which are positioned downstream from a turbine exhaust duct of the gas turbine. During fired operation of the gas turbine, hot combustion exhaust gases flow from the exhaust duct, through the HRSG and out an exhaust stack. Thermal energy from the hot combustion exhaust gas is transferred via the heat exchanger(s) to a working fluid such as water so as to provide a flow of pressurized steam to the steam turbine(s).

In certain instances, the gas turbine may be operated primarily during peak or high power demand periods and shut down during non-peak or low demand periods. During a shut-down or non-fired operational period, however, it may be generally desirable to keep the rotor shaft of the gas turbine rotating at some desired minimal rotational speed via a turning gear which is coupled to an electric motor in order to protect the gas turbine rotor from bowing.

As the rotor is turned via the turning gear, ambient air is drawn through the compressor section, routed into a compressor discharge casing of the combustion section, routed through the turbine section out the exhaust duct and then through the HRSG. Although the air flowing from the compressor during turning gear operation may realize a slight increase in thermal energy, the temperature of the air passing from the compressor into the HRSG may be lower than the temperature of the working fluid residing in the heat exchangers of the HRSG, particularly soon after fired-operation of the gas turbine has ceased. As a result, thermal energy from the working fluid within the heat exchanger is lost to the cooler exhaust air.

The loss of thermal energy from the working fluid in the HRSG during turning gear operation may negatively impact overall power plant performance. For example, additional time may be required to bring the working fluid within the HRSG back to a required operating temperature before full operation of both the gas turbine and the steam turbine may be realized. In addition, a large temperature differential between the working fluid in the HRSG and the hot turbine exhaust gas, particularly during the initial start-up period, may result in thermal stresses on various components of the HRSG which may impact overall HRSG performance. Accordingly, a system and method for conserving thermal losses from the HRSG working fluid during turning gear operation of the gas turbine would be useful.

### BRIEF DESCRIPTION OF THE INVENTION

Aspects and advantages of the invention are set forth below in the following description, or may be obvious from the description, or may be learned through practice of the invention.

One embodiment of the present invention is a combined cycle power plant. The combined cycle power plant comprises a compressor, a combustion section including a compressor discharge casing which is disposed downstream from the compressor, a turbine disposed downstream from the combustion section and an exhaust duct disposed downstream from the turbine section. The compressor, the compressor discharge casing, the turbine and the exhaust duct define a primary flow passage through the gas turbine. A heat recovery steam generator is in thermal communication with the exhaust duct and in fluid communication with a steam turbine. A blower is in fluid communication with the primary flow passage upstream from the heat recovery steam generator such that the blower draws compressed air from the primary flow passage during turning gear operation of the gas turbine.

Another embodiment of the present disclosure is a combined cycle power plant. The combined cycle power plant comprises a gas turbine having a compressor, a combustion section including a compressor discharge casing disposed downstream from the compressor, and a turbine disposed downstream from the combustion section. The compressor discharge casing defines a compressed air plenum therein. The compressor, the compressor discharge casing and the turbine define a primary flow passage which extends through the gas turbine. A heat recovery steam generator is disposed downstream from the turbine and is configured to receive exhaust air flow from the primary flow passage. A steam turbine is in fluid communication with the heat recovery steam generator. A blower is in fluid communication with the primary flow passage upstream from the heat recovery steam generator. The blower draws air from the primary flow passage during turning gear operation of the gas turbine.

The present invention also includes a method for conserving thermal energy of a combined cycle power plant during turning gear operation. The combined cycle power plant including a gas turbine, a heat recovery steam generator downstream from an exhaust outlet of the gas turbine and a steam turbine fluidly coupled to the heat recovery steam generator. The method includes rotating a rotor shaft of the gas turbine via a turning gear where rotation of the rotor shaft causes air to flow into a primary flow passage of the gas turbine. The primary flow passage is in fluid communication with the heat recovery steam generator. The method further includes energizing a blower which is fluidly coupled to a bleed air outlet of the gas turbine where the bleed air outlet is in fluid communication with the primary flow passage. The method also includes extracting at least a portion of the air flowing through the primary flow passage through the bleed air outlet upstream from the heat recovery steam generator via the blower.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a functional block diagram of an exemplary gas turbine that may incorporate various embodiments of the present invention;

FIG. 2 is a functional block diagram of an exemplary gas turbine as shown in FIG. 1, according to various embodiments of the present invention; and

FIG. 3 is a flow chart illustrating a method for conserving thermal energy within a combined cycle power plant according to one embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. Although exemplary embodiments of the present invention will be described generally in the context of a combined cycle power plant having a single gas turbine, a single steam turbine and a single heat recovery steam generator, particularly a single heat exchanger, for purposes of illustration, one of ordinary skill in the art will readily appreciate that embodiments of the present invention may be applied to any combined cycle power plant having multiple gas turbines, steam turbines and/or multiple HRSG units.

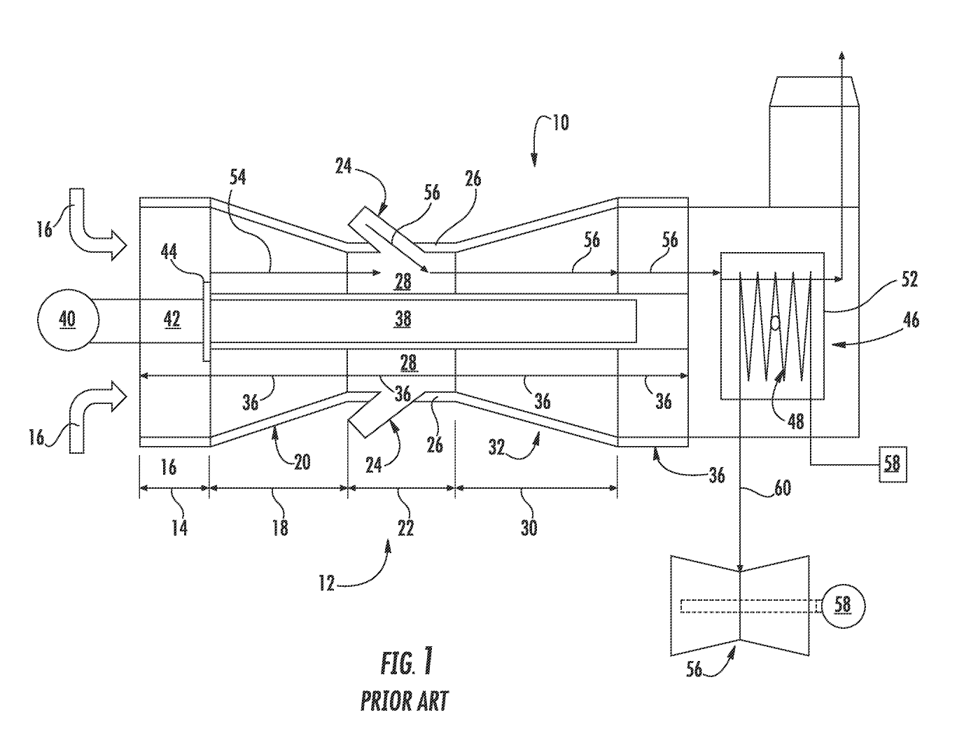

Referring now to the drawings, wherein identical numerals indicate the same elements throughout the figures, FIG. 1 provides a functional block diagram of an exemplary combined cycle power plant 10 that may incorporate various embodiments of the present invention. As shown in FIG. 1, the power plant 10 includes a gas turbine 12. The gas turbine 12 generally includes an inlet section 14 that may include a series of filters, cooling coils, moisture separators, and/or other devices (not shown) to purify and otherwise condition a working fluid (e.g. air) 16 entering the gas turbine 12. A compressor section 18 including a compressor 20 is disposed downstream from the inlet section 14. A combustion section 22 including a plurality of combustors 24 annularly arranged around an outer casing 26 such as a compressor discharge casing is disposed downstream from the compressor 20. In particular embodiments, the outer casing 26 defines a high pressure plenum 28 therein.

A turbine section 30 including a high and/or low pressure turbine 32 is disposed downstream from the combustion section 22. In one embodiment, the gas turbine includes an exhaust duct 34 disposed downstream from the turbine 32. In particular embodiments, the compressor 20, the outer casing 26 of the combustion section 22, the turbine 32 and the exhaust duct 34 define a primary flow passage 36 through the gas turbine 12. A rotor shaft 38 extends along an axial centerline of the gas turbine 12. In one embodiment, a generator/motor 40 is coupled to the rotor shaft 38 via an extension shaft 42 and/or a turning gear 44.

In particular embodiments, the power plant 10 includes a heat recovery steam generator 46 disposed downstream from at least one of the turbine 32 and the exhaust duct 34. The heat recovery steam generator 46 generally includes at least one heat exchanger 48 which is in fluid communication with the primary flow passage 36 of the gas turbine 12. The heat exchanger(s) 48 is fluidly coupled to one or more steam turbines 50 which may be connected to a generator 52.

During fired operation of the gas turbine 12, the air 16 passes through the inlet section 14 and into the compressor 20 where it is progressively compressed as it flows across multiple rows or stages of stationary vanes and rotating compressor blades (not shown) which are coupled to the rotor shaft 38. Compressed air 54 is routed from the compressor 20 along the primary flow passage 36 and into the outer casing 26 and/or air plenum 28 of the combustion section 22. At least a portion of the compressed air 54 is routed into the various combustors 24 where it is mixed with fuel to provide a combustible fuel-air mixture. The fuel-air mixture in each combustor 24 is burned to provide combustion gases 56 at high temperature, pressure and velocity. The combustion gases 56 are then routed into the turbine 32 wherein kinetic and thermal energy is extracted from the combustion gases via one or more rows or stages of stationary vanes and rotatable turbine rotor blades which are coupled to the rotor shaft 38, thus causing the rotor shaft 38 to rotate.

The combustion gases 56 are exhausted from the turbine 34 via the exhaust duct 34 and are routed into the heat recovery steam generator 46. Remaining thermal energy from the exhausted combustion gases 56 is transferred to a working fluid 58 such as water via the heat exchanger 48. The thermal energy transferred is generally sufficient to convert the working fluid 58 to steam 60. The steam 60 is then routed to the steam turbine 50.

Once the gas turbine is shut down or operating in a non-fired condition, the turning gear 44 may be engaged in order to keep the rotor shaft 38 rotating, thus reducing the potential for bowing of the rotor shaft 38 and/or to improve start-up time required to bring the combined cycle power plant 10 back online. As the turning gear rotates the rotor shaft 38 air 16 is drawn through the inlet 14 and into compressor 20 where it flows along the primary flow passage 36 through the outer casing 26 of the combustion section 22, through the turbine 32, the exhaust duct 34 and across the heat exchanger 48 of the heat recovery steam generator 46. The air 16 flowing through the primary flow passage 36 and across the heat exchanger 48 may be relatively cool when compared to the working fluid 58 being stored within the heat exchanger 48. As a result, thermal energy may be lost to the cooler working fluid, thus potentially reducing overall efficiency of the heat recovery steam generator 46 and/or the combined cycle power plant 10.

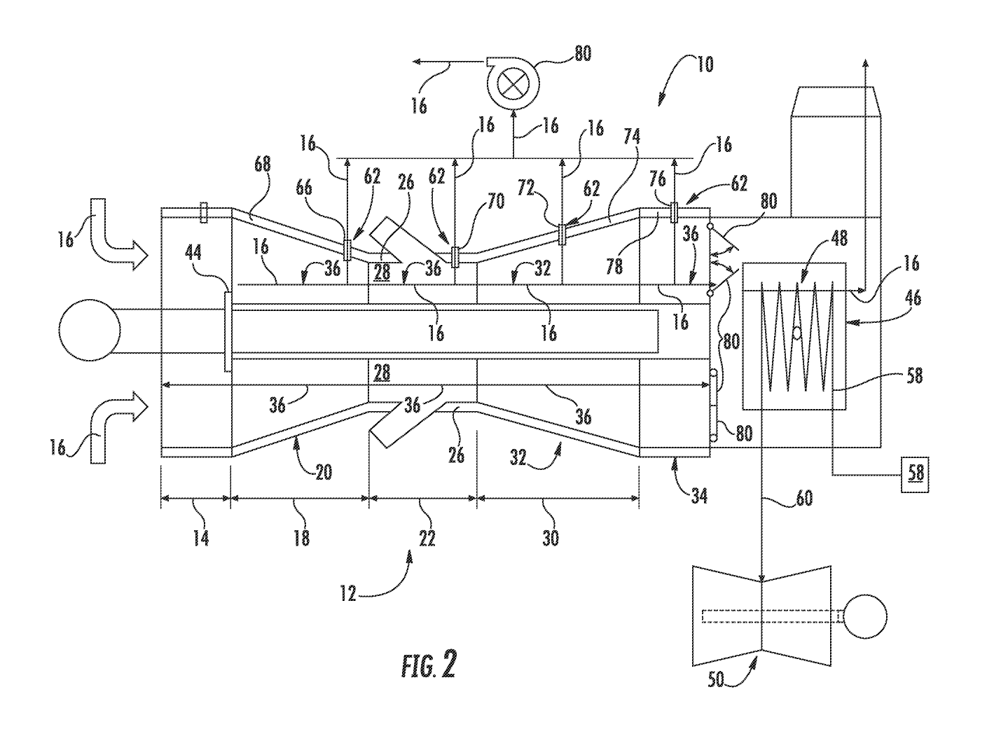

FIG. 2 provides a schematic side view of the exemplary combined cycle power plant 10 as shown in FIG. 1, according to various embodiments of the present invention. In particular embodiments, the combined cycle power plant includes one or more bleed air outlets 62 in fluid communication with a blower or air pump 64. The bleed air outlet(s) 62 may be defined at various points along the gas turbine 12 upstream from the heat recovery steam generator 46, particularly upstream from the heat exchanger 48.

In one embodiment, a bleed air outlet 66 extends through an outer casing 68 of the compressor 20 and is in fluid communication with a portion of the primary flow passage 36 defined within the compressor 20. In one embodiment, a bleed air outlet 70 extends through the outer casing 26 of the combustion section 22 and is in fluid communication with a portion of the primary flow passage 36 defined within the outer casing 26 and/or the high pressure plenum 28. In one embodiment, a bleed air outlet 72 extends through an outer casing 74 of the turbine 32 and is in fluid communication with a portion of the primary flow passage 36 defined within the turbine 32. In one embodiment, a bleed air outlet 76 extends through an outer casing 78 of the exhaust duct 34 and is in fluid communication with a portion of the primary flow passage 36 defined within the exhaust duct 34.

The combined cycle power plant 10 may include any or all the bleed air outlets 62 as shown in FIG. 2. The bleed air outlets 62 are not limited to any particular location along a particular section or component of the gas turbine 12 unless specifically recited in the claims. The combined cycle power plant 10 may include multiple bleed air outlets. The blower 64 may include any blower motor, air pump or apparatus suitable for drawing the air 16 from the primary flow passage 36 in the corresponding section or component of the gas turbine 12 during turning gear operation of the gas turbine 12.

In particular embodiments, the combined cycle power plant may include at least one moveable hatch 80 disposed within the primary flow passage 36 upstream from the heat recovery steam generator 46 where the hatch 80 or hatches at least partially restrict flow through the primary flow passage 36 to the heat recovery steam generator 46 during turning gear operation of the gas turbine 12. As shown in FIG. 2, some of the hatches 80 may be at least partially open to relieve pressure within the primary flow passage 36, while other hatches 80 may be fully closed to full restrict or prevent flow or the air 16 into the heat recovery steam generator 46.

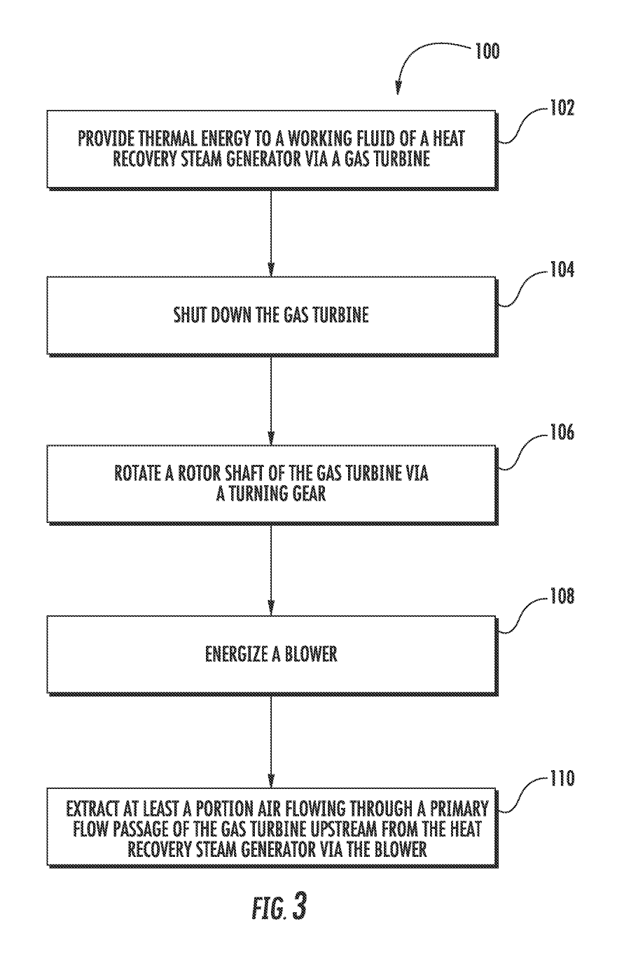

The bleed air outlets 62, the motor 64 and/or the hatches 80 may provide a method 100 for conserving thermal energy within the combined cycle power plant 10. For example, as shown in FIG. 3 at step 102, thermal energy may be provided to the heat recovery steam generator 46 during fired operation of the gas turbine 12 via the combustion gases 56. At step 104, the gas turbine may be shut down, thus leaving thermal energy stored in the working fluid 58 of the heat recovery steam generator 46. At step 106 the turning gear 44 and/or the motor 40 may be engaged to rotate the rotor shaft 38 where the rotation of the rotor shaft 38 causes air 16 to flow into the primary flow passage 36 of the gas turbine 12. At step 106 the blower 64 may be energized. At step 108 at least a portion of the air 16 flowing through the primary flow passage 36 may be extracted through the bleed air outlet 62 upstream from the heat recovery steam generator 46.

In one embodiment, at least a portion of the air 16 flowing through the primary flow passage 36 may be extracted from the compressor 20 of the gas turbine 12 via bleed air outlet 66. In one embodiment, at least a portion of the air 16 flowing through the primary flow passage 36 may be extracted from the outer casing 26 of the combustion section 22 of the gas turbine 12 via bleed air outlet 70. In one embodiment, at least a portion of the air 16 flowing through the primary flow passage 36 may be extracted from the turbine 32 of the gas turbine 12 via bleed air outlet 72. In one embodiment, at least a portion of the air 16 flowing through the primary flow passage 36 may be extracted from the exhaust duct 34 of the gas turbine 12 via bleed air outlet 76.

In addition, the method may further include restricting flow of the air 16 flowing from the primary flow passage 36 towards the heat recovery steam generator 46. For example, in one embodiment, the flow of the air 16 may be restricted via the hatch 80 or hatches disposed upstream from the heat recovery steam generator 46. The method 100 may further include adjusting the hatch 80 or hatches 80 to control the flow of air 16 flowing towards the heat recovery steam generator 46. For example, the hatch 80 or hatches 80 may be at least partially closed or fully closed.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A combined cycle power plant, comprising:
a gas turbine having a compressor, a combustion section including a compressor discharge casing disposed downstream from the compressor, a turbine downstream from the combustion section and an exhaust duct downstream from the turbine section, wherein the compressor, the compressor discharge casing, the turbine and the exhaust duct define a primary flow passage through the gas turbine;
a heat recovery steam generator in thermal communication with the exhaust duct and in fluid communication with at least one steam turbine; and
a blower in fluid communication with the primary flow passage upstream from the heat recovery steam generator, wherein the blower draws compressed air from the primary flow passage during turning gear operation of the gas turbine.

2. The combined cycle power plant as in claim 1, wherein the blower is in fluid communication with the primary flow passage via a bleed air outlet of the compressor.

3. The combined cycle power plant as in claim 1, wherein the blower is in fluid communication with the primary flow passage via a bleed air outlet of the compressor discharge casing.

4. The combined cycle power plant as in claim 1, wherein the blower is in fluid communication with the primary flow passage via a bleed air outlet of the turbine.

5. The combined cycle power plant as in claim 1, wherein the blower is in fluid communication with the primary flow passage via a bleed air outlet of the exhaust duct.

6. The combined cycle power plant as in claim 1, further comprising a moveable hatch disposed within the primary flow passage upstream from the heat recovery steam generator, wherein the hatch at least partially restricts flow through the primary flow passage to the heat recovery steam generator during turning gear operation of the gas turbine.

7. A combined cycle power plant, comprising:
a gas turbine having a compressor, a combustion section including a compressor discharge casing disposed downstream from the compressor, and a turbine downstream from the combustion section, the compressor discharge casing defining a compressed air plenum therein, wherein the compressor, the compressor discharge casing and the turbine define a primary flow passage through the gas turbine;
a heat recovery steam generator disposed downstream from the turbine and configured to receive exhaust air flow from the primary flow passage;
a steam turbine in fluid communication with the heat recovery steam generator; and
a blower in fluid communication with the primary flow passage upstream from the heat recovery steam generator, wherein the blower draws air from the primary flow passage during turning gear operation of the gas turbine.

8. The combined cycle power plant as in claim 7, wherein the blower is in fluid communication with the primary flow passage via a bleed air outlet of the compressor.

9. The combined cycle power plant as in claim 7, wherein the blower is in fluid communication with the primary flow passage via a bleed air outlet of the compressor discharge casing.

10. The combined cycle power plant as in claim 7, wherein the blower is in fluid communication with the primary flow passage via a bleed air outlet of the turbine.

11. The combined cycle power plant as in claim 7, further comprising a moveable hatch disposed within the primary flow passage upstream from the heat recovery steam generator, wherein the hatch at least partially restricts flow through the primary flow passage to the heat recovery steam generator during turning gear operation of the gas turbine.

12. A method for conserving thermal energy of a combined cycle power plant during turning gear operation, the combined cycle power plant including a gas turbine, a heat recovery steam generator downstream from an exhaust outlet of the gas turbine and a steam turbine fluidly coupled to the heat recovery steam generator, the method comprising:
providing thermal energy to a working fluid of the heat recovery steam generator during fired operation of the gas turbine;
shutting down the gas turbine;
rotating a rotor shaft of the gas turbine via a turning gear, wherein rotation of the rotor shaft causes air to flow into a primary flow passage of the gas turbine, wherein the primary flow passage is in fluid communication with the heat recovery steam generator;
energizing a blower, wherein the blower is fluidly coupled to a bleed air outlet in fluid communication with the primary flow passage; and
extracting at least a portion of the air flowing through the primary flow passage through the bleed air outlet upstream from the heat recovery steam generator via the blower.

13. The method as in claim 12, wherein at least a portion of the air flowing through the primary flow passage is extracted from a compressor of the gas turbine.

14. The method as in claim 12, wherein at least a portion of the air flowing through the primary flow passage is extracted from a combustion section of the gas turbine.

15. The method as in claim 12, wherein at least a portion of the air flowing through the primary flow passage is extracted from a compressor discharge casing of the gas turbine.

16. The method as in claim 12, wherein at least a portion of the air flowing through the primary flow passage is extracted from a turbine of the gas turbine.

17. The method as in claim 12, wherein at least a portion of the air flowing through the primary flow passage is extracted from an exhaust duct of the gas turbine.

18. The method as in claim 12, further comprising restricting flow of the air flowing from the primary flow passage towards the heat recovery steam generator.

19. The method as in claim 18, wherein the flow of the air is restricted via a hatch disposed upstream from the heat recovery steam generator.

20. The method as in claim 19, further comprising adjusting the hatch to control the flow of air flowing towards the heat recovery steam generator.
